(19) United States
(12) Patent Application Publication
(10) Pub. No.: US 2024/0111857 A1
(43) Pub. Date: Apr. 4, 2024

(54) SECURE EXECUTION OF A FILE ON A COPY DEVICE IN A VIRTUALIZED COMPUTING ENVIRONMENT

(71) Applicant: VMware, Inc., Palo Alto, CA (US)

(72) Inventor: Amit Anandram LUNIYA, Pune (IN)

(73) Assignee: VMware, Inc., Palo Alto, CA (US)

(21) Appl. No.: 17/958,327

(22) Filed: Oct. 1, 2022

(51) Int. Cl. G06F 21/53; G06F 21/55

(52) U.S. Cl. CPC G06F 21/53; G06F 21/554; G06F 2221/034

(57) ABSTRACT

Techniques are provided to prevent or allow the execution of a file from a copy device, such as a shadow copy device, depending on whether the file includes malicious code or trusted code. Redirection techniques may be used to cause a file (stored in the copy device) to be analyzed for malicious code at an original volume, rather than being analyzed at or executed from the copy device.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualization computing instances such as virtual machines (VMs) running different operating systems may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

To protect against a potential disaster (e.g., data loss/corruption in the VMs and/or hosts) caused by certain types of events (e.g., power or network outages, system malfunctions, etc.), virtualized computing environments typically implement various replication/backup solutions. An example is a shadow copy process or other analogous technology that creates snapshots or other backup copies of computer files or volumes (e.g., a logical drive or similar logical/virtual arrangement of storage locations, referred to herein as a copy device such as a shadow copy device). Through the shadow copy process, consistency may be provided between snapshots and volumes of a filesystem.

A virtualized computing environment having hosts that support VMs and their volumes is often targeted by malware, viruses, or other types of malicious code. While security solutions (e.g., a security agent) attempt to guard against such malicious code, such security solutions often have flaws or other vulnerabilities to exploits from malicious code. Such exploits may be directed towards copy devices and their contents.

### BRIEF DESCRIPTION OF DRAWINGS

FIG. 1 is a schematic diagram illustrating an example virtualized computing environment that can implement a method to handle execution of file(s) from a shadow copy device;

FIG. 2 is a schematic diagram illustrating a shadow copy framework that may be implemented in the virtualized computing environment of FIG. 1;

FIG. 3 is a flowchart of an example method that can be performed in the virtualized computing environment of FIG. 1 to handle attempts to execute files from a shadow copy device;

FIG. 4 is an example screen output that shows the mapping between a shadow copy volume and an original volume for a redirection technique;

FIG. 5 is an example workflow of the redirection technique; and

FIG. 6 is another example workflow of the redirection technique.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses drawbacks of security solutions for a virtualized computing environment, by providing techniques to guard against or otherwise handle malicious code that targets virtual/logical copy devices such as shadow copy devices. For example, existing security solutions have a drawback in that it is possible to execute malicious code from a shadow copy device, such as by placing a malicious file on an original device/volume, taking a snapshot of that device (having the malicious file placed therein) before the security solution is able to analyze that device, and then executing the malicious file from the shadow copy device.

The embodiments disclosed herein address the above and other drawbacks by providing techniques to prevent or allow the execution of a file from a copy device, depending on whether the file includes malicious code or approved (e.g., trusted) code. Furthermore, redirection techniques may be used to cause a file (stored in the copy device) to be analyzed for malicious code at an original volume, rather than being analyzed at or executed from the copy device.

Computing Environment

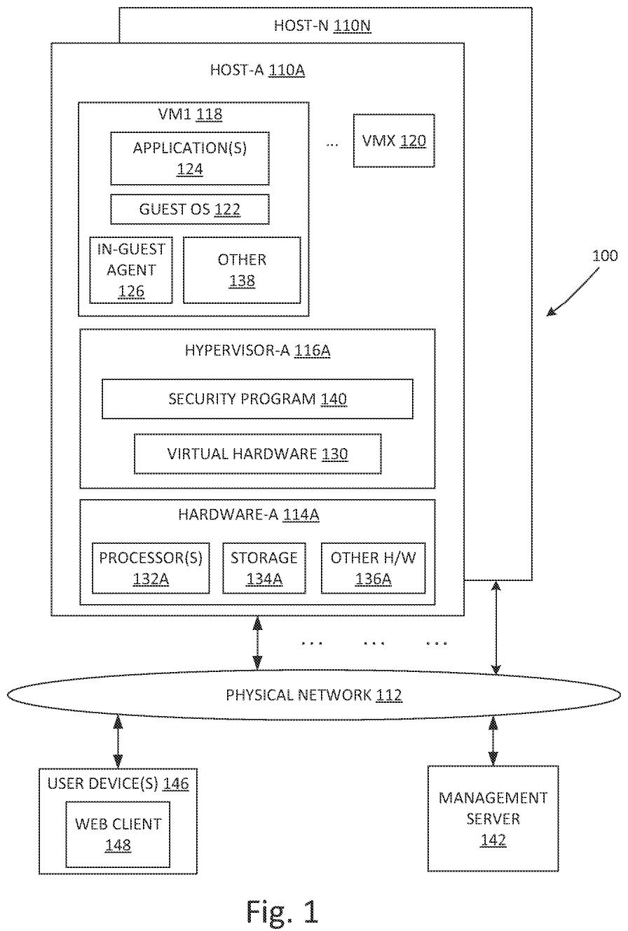

To further explain the operation of techniques to detect and address malicious files that attempt to execute from a copy device, various implementations will now be explained in more detail using FIG. 1, which is a schematic diagram illustrating an example virtualized computing environment 100 that can implement a method to handle execution of file(s) from a shadow copy device. Depending on the desired implementation, virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other host-N 110N can include substantially similar elements and features.

The host-A 110A includes suitable hardware 114A and virtualization software (e.g., hypervisor-A 116A) to support various virtual machines (VMs). For example, the host-A 110A supports VM1 118 . . . VMX 120, wherein X (as well as N) is an integer greater than or equal to 1. In practice, the virtualized computing environment 100 may include any number of hosts (also known as a computing devices, host computers, host devices, physical servers, server systems, physical machines, etc.), wherein each host may be supporting tens or hundreds of virtual machines. For the sake of simplicity, the details of only the single VM1 118 are shown and described herein.

VM1 118 may be a guest VM that includes a guest operating system (OS) 122 and one or more guest applications 124 (and their corresponding processes) that run on top of the guest operating system 122. VM1 118 may also include an agent 126 (in-guest security agent). The agent 126 of various embodiments may be in the form of a daemon or other software/code that runs in a background process. The agent 126 may run as part of the guest OS 122 in one example implementation. The agent 126 may first run in a learning mode for a period of time, in which the agent 126 monitors the operation of VM1 118 in order to generate a whitelist of expected operational behavior of VM1 118, such as valid operations and tasks of files that are executed by VM1 118 under normal/routine circumstances. The agent 126 may then run in a protected mode to monitor VM1 118 to ensure that operations/tasks performed by VM1 118 during the course of executing files are present in the whitelist—the agent 126 validates operations that are found on the whitelist, and creates an alarm for operations that violate the whitelist (e.g., operations that are not present on the whitelist or are modifications of valid operations on the whitelist). Techniques other than or in addition to whitelisting may be used by the agent 126 to determine whether files (including their corresponding operations) are approved/trusted files or malicious files. Such other techniques to determine whether a file/operation is malicious may be based on reputations, rules, etc. Further details of the features and operation of the agent 126 in connection with controlling the execution of files from shadow copy devices will be described later below.

VM1 118 may also include other components 138 that are configured to support operation of VM1 118, including security-related operations that pertain to controlling the execution of files from shadow copy devices and/or from original volumes. The various components of VM1 118 (such as the agent 126) of one embodiment may be any suitable software program or other computer-readable instructions/code stored on a non-transitory computer-readable medium, and executable by one or more processors.

The hypervisor 116A may be a software layer or component that supports the execution of multiple virtualized computing instances. The hypervisor 116A may run on top of a host operating system (not shown) of the host-A 110A or may run directly on hardware 114A. The hypervisor 116A maintains a mapping between underlying hardware 114A and virtual resources (depicted as virtual hardware 130) allocated to VM1 118 and the other VMs.

Hardware 114A in turn includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each virtual machine to support a guest operating system (OS) and application(s) in the virtual machine, such as the guest OS 122 and the applications 124 (e.g., a word processing application, accounting software, a browser, etc.) in VM1 118. Corresponding to the hardware 114A, the virtual hardware 130 may include a virtual CPU, a virtual memory, a virtual disk, a virtual network interface controller (VNIC), etc.

According to various embodiments, the storage device(s) 134A can provide physical and/or virtual storage capacity for use by the VMs on the host-A 110A and/or for use by other hosts (e.g., in a shared/distributed storage implementation). For example, the storage device(s) 134 may provide memory and/or disk space that are usable to store files. The files may in turn be stored in a volume or other logical/physical storage configuration. Volumes (e.g., one or more drives arranged logically/virtually as a device or pseudo device), including copy devices such as shadow copy devices, may be created, configured, and maintained in the storage device(s) 134A.

A security program 140 may run on top of or within the hypervisor-A 116A. In the example embodiment of FIG. 1, the security program 140 is depicted as running within or as part of the hypervisor-A 116A. In other embodiments, the security program 140 may run within or may be installed at other locations within the host-A 110A. The security program 140 may be configured in one embodiment to receive alerts from the agent 126 about possible malicious code, and to take a remedial action in response to an alert from the agent 126. For example, the security program 140 may take remedial actions such as shutting down VM1 118, disabling the guest OS 122, preventing or stopping the execution of files, sending a report or forwarding the alert to a management server 142 so as to enable a system administrator to further evaluate the alert(s) from the agent 126, etc. In some embodiments, the agent 126 can be part of the security program 140.

Although FIG. 1 shows the security program 140 as a single discrete component, the security program 140 of another embodiment can be implemented using distributed components that include or otherwise work in conjunction with the agent 126, the management server 142, and/or other components in the virtualized computing environment 100.

The management server 142 of one embodiment can take the form of a physical computer with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster. The functionality of the management server 142 may be accessed via one or more user devices 146 that are operated by a system administrator. For example, the user device 146 may include a web client 148 (such as a browser-based application) that provides a user interface operable by the system administrator to view and evaluate alerts provided by the agent 126 to the management server 142. The system administrator may then operate the user interface of the web client 148 to facilitate the implementation of a remediation action, such as shutting down a VM, disabling a guest OS, debugging, preventing file execution, troubleshooting, etc.

The management server 142 may be communicatively coupled to host-A 110A . . . host-N 110N (and hence communicatively coupled to the virtual machines, hypervisors, agents, hardware, etc.) via the physical network 112. The host-A 110A . . . host-N 110N may in turn be configured as a datacenter that is managed by the management server 142, and the datacenter may support a web site. In some embodiments, the functionality of the management server 142 may be implemented in any of host-A 110A . . . host-N 110N, instead of being provided as a separate standalone device such as depicted in FIG. 1.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

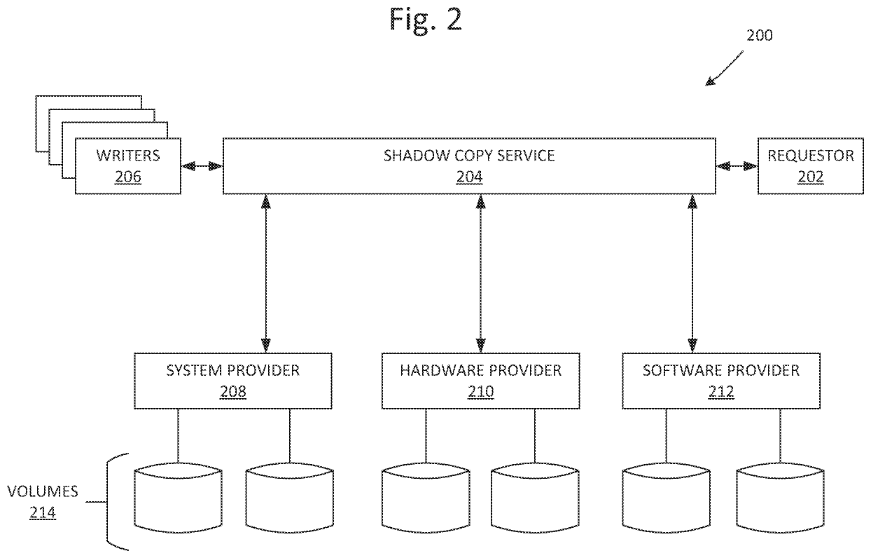

Referring next to FIG. 2, FIG. 2 is a schematic diagram illustrating a shadow copy framework 200 that may be implemented in the virtualized computing environment 100 of FIG. 1. Elements of the framework 200 may be implemented by the guest OS 122, the application 124, and/or by other components 138 in VM1 118 or elsewhere in host-A 110A.

In the framework 200, a requestor 202 (e.g., one of the applications 124 of FIG. 1 or some other component of VM1 118) communicates with a shadow copy service 204 to request a snapshot. The shadow copy service 204 (which may be a component of the OS 122 in some implementations) then coordinates with one or more writers 206 and one or more providers (e.g., a system provider 208, a hardware provider 210, a software provider 212) to create a snapshot of the files or volumes requested by the application 124. Such snapshots may be in the form of shadow copy volumes 214 (e.g., shadow copy devices).

Secure Execution of Files on a Shadow Copy Device

In the above-described virtualized computing environment 100 and framework 200, at least two possible exploits may be attempted in order to execute malicious code.

As a first example scenario:
1. File X [clean.exe] and file Y [bad.exe] are present in the filesystem of VM1 118.
2. File X [clean.exe] is a legitimate file to execute (e.g., is an approved/trusted file).
3. File Y [bad.exe] is an unapproved file to execute (e.g., is a malicious file or potentially malicious file).
4. A bad actor writes malicious content from file Y to file X, and before analysis of this file X by the agent 126, the bad actor causes the shadow copy service 204 to create a snapshot of a source volume (on which this file X is stored) and attempts to execute file X from the shadow copy device.

As a second example scenario:
1. File Y [bad.exe] is present in the filesystem of VM1 118, or has been recently downloaded to the filesystem.
2. File Y [bad.exe] is an unapproved file to execute (e.g., is a malicious file or potentially malicious file).
3. A bad actor takes a snapshot of a volume where file Y is present.
4. The bad actor can then execute file Y [bad.exe] from the shadow copy device, and a security agent may not be able to detect this attempt to execute a malicious file, if the execution of a shadow copy is not handled correctly.

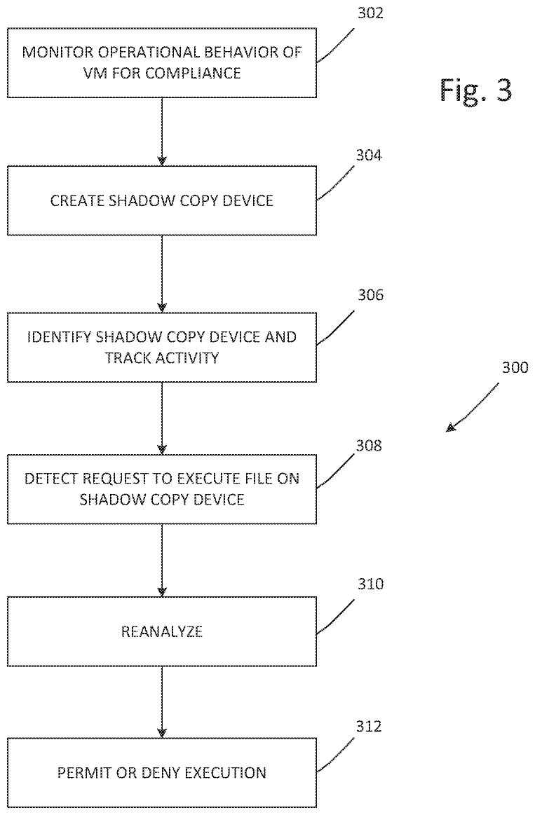

FIG. 3 is a flowchart of an example method 300 that can be performed in the virtualized computing environment 100 of FIG. 1 to handle attempts to execute files from a shadow copy device. The example method 300 may include one or more operations, functions, or actions illustrated by one or more blocks, such as blocks 302 to 312. The various blocks of the method 300 and/or of any other process(es) described herein may be combined into fewer blocks, divided into additional blocks, supplemented with further blocks, and/or eliminated based upon the desired implementation. In one embodiment, the operations of the method 300 may be performed in a pipelined sequential manner. In other embodiments, some operations may be performed out-of-order, in parallel, etc.

According to one embodiment, some operations of the method 300 may be performed by the agent 126 (residing in host-A 110A), which may form part of the security program 140, by the OS 122, and/or by some other component of VM1 118 or the host-A 110A.

At a block 302 (“MONITOR OPERATIONAL BEHAVIOR OF VM FOR COMPLIANCE”), the agent 126 is monitoring the operation(s) performed by VM1 118 by comparing such operation(s) against the expected operational behavior for VM1 118 (e.g., checking the operations against a baseline such as a whitelist, reputation, rules, etc.). For example, the agent 126 may analyze files and/or operations being performed when the files are being executed, so as to monitor, detect, and protect against unauthorized activity by malicious code. The agent 126 may also monitor data and metadata changes to files present on all volumes mounted on the filesystem.

At a block 304 (“CREATE SHADOW COPY DEVICE”), a shadow copy device is created when a snapshot of a volume in the filesystem is taken. At a block 306 (“IDENTIFY SHADOW COPY DEVICE AND TRACK ACTIVITY”), the agent 126 identifies the shadow copy device that has been created and attaches to the shadow copy device so as to track traffic and other activity on the shadow copy device. For instance, the shadow copy device may be identified by extracting its volume globally unique identifier (GUID) partition table (GPT) attribute whenever a new shadow copy device is attached to a stack. The volume GPT attribute may be, for example, GPT_BASIC_DATA_ATTRIBUTE_SHADOW_COPY.

When the agent 126 starts monitoring the shadow copy device at the block 306, the agent 126 monitors for all execution or attempts/requests for execution from the shadow copy device. At a block 308 (“DETECT REQUEST TO EXECUTE FILE ON SHADOW COPY DEVICE”), the agent 126 detects a request to execute a file that is contained/stored in the shadow copy device.

At a block 310 (“REANALYZE”) and prior to permitting execution, the agent 126 performs an analysis of the file on the shadow copy device. This analysis at the block 310 may be a reanalysis, in that the file may have been initially analyzed previously by the agent at the block 302 and determined to be a trusted file—however, malicious code may have potentially landed on the file after the initial analysis and prior to the snapshot being taken at the block 304—therefore, reanalysis is performed at the block 310 in order to determine whether or not the file in the shadow copy device contains malicious code.

At a block 312 (“PERMIT OR DENY EXECUTION”), the security agent 126 permits or denies the execution of the file from the shadow copy device, depending on whether the analysis at the block 310 detects the presence of malicious code in the file. If malicious code has been detected and so execution is prevented from starting (or is terminated if started), the security agent 126 can initiate other remedial actions, such as sending a notification to the security program 140 so as to alert a system administrator, deleting the malicious file from the shadow copy device, deleting or disabling the shadow copy device, etc.

The foregoing description of the example method 300 involved a situation wherein the file was permitted to execute from the shadow copy device, or denied execution from the shadow copy device. There may be scenarios in which it is desired to execute a trusted file from the shadow copy device, but such file cannot be trusted without first performing the reanalysis at the block 310. In some situations, performing the reanalysis (at the block 310) of the file contained in the shadow copy device may cause additional workload on the agent 126 in a manner that could affect performance, such as by causing latency.

Therefore, and in accordance with some embodiments, a redirection technique may be provided in which a request to execute a file (from a shadow copy device) is redirected to the original volume, in a manner that avoids performing an analysis/reanalysis of the file contained in the shadow copy device.

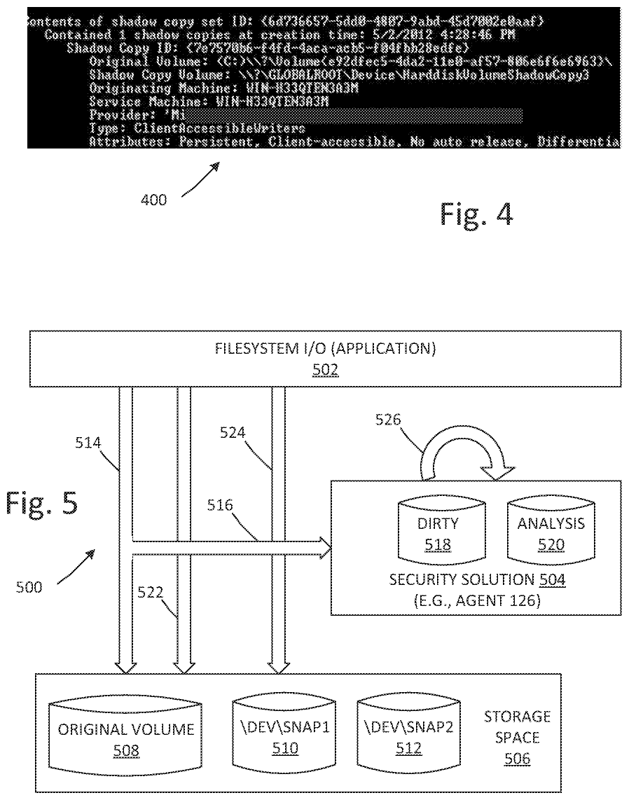

The redirection technique of various embodiments is based at least in part on a shadow copy cache map or other mapping technique in which the shadow copy volume is mapped or otherwise linked/related to the original volume. Referring to FIG. 4, FIG. 4 is an example screen output 400 that shows the mapping between a shadow copy volume and an original volume for a redirection technique.

The example output 400 shows that the shadow copy volume has a unique GUID (“Shadow Copy ID:”). The example output further identifies the path to the original volume (“Original Volume:”) and to the shadow copy volume (“Shadow Copy Volume:”) that is mapped to the original volume.

According to various embodiments, every time that a shadow copy device is created, the security agent 126 attaches to the shadow copy device to obtain the GUID, and sends a notification (e.g., to the OS 122 or other component that creates and maintains the shadow copy cache map) to refresh the map to indicate the addition (or removal) of the snapshot (shadow copy device). In terms of lifecycle, snapshot information is inserted into the shadow copy cache map whenever a new snapshot is detected and attached by the agent 126. Removal of an entry from the cache map may occur whenever a snapshot is deleted or detached.

The GUID of the shadow copy volume is used as a key in the map during the redirection process, so as to identify the original volume that corresponds to a shadow copy device having a file that is being requested to be executed, and to enable redirection of the execution request to the original volume. After identification of the original volume, the execution request is redirected to the original volume, in a manner that will be explained next below.

Considering an example scenario as follows, which has similarities to the first example scenario described previously above:
1. File X [clean.exe] and file Y [bad.exe] are present in the filesystem of VM1 118.
2. File X [clean.exe] is a legitimate file to execute (e.g., is an approved/trusted file).
3. File Y [bad.exe] is an unapproved file to execute (e.g., is a malicious file or potentially malicious file).
4. A bad actor writes malicious content from file Y to file X, and before analysis of this file X by the agent 126, the bad actor causes the shadow copy service 204 to create a snapshot of a source/original volume (on which this file X is stored) and attempts to execute file X from the shadow copy device.
5. At item 4 above, the agent 126 tracks the creation of the snapshot and attaches to the snapshot volume (shadow copy device).

FIG. 5 is an example workflow 500 of the redirection technique, in accordance with various embodiments, that may be performed for the example scenario described above. The workflow 500 involves filesystem input/output 502 (e.g., performed by an application), a security solution 504 (e.g., the agent 126), and a storage space 506 having an original/source volume 508 and one or more shadow copy devices (e.g., \dev\snap1 510 and \dev\snap2 512).

At 514, a file write operation is performed to write the filename C:\foo\clean.exe to the source volume 508. At this point, the shadow copy cache map is empty, since a snapshot has not yet been performed. Furthermore, content of the malicious file bad.exe is written or may have been written to the clean.exe file. The particular file clean.exe (having content from the malicious file bad.exe possibly written thereon) is placed (at 516) in a dirty queue 518 of the agent 126, so as to be queued for analysis at 520 for malicious code.

At 522 and prior to completion of the above analysis at 520, an operation is performed to create a snapshot of the original volume C:\, and the snapshot (shadow copy volume) is depicted in FIG. 5 as the shadow copy device dev\snap1 510. The content of the shadow copy cache map is updated to add an entry that maps the GUID of the shadow copy volume to the original volume C:\.

At 524, a request to execute the file contained in the shadow copy volume (e.g., \dev\snap1\foo\clean.exe, which is or may be infected with malicious code) is detected by the agent 126. The agent 126 of various embodiments replaces the path in the request, from the shadow copy device dev\snap1 510 to the source volume 508 at C:\foo\clean.exe. The agent 126 performs a lookup of the dirty queue 518, and determines that the file clean.exe is queued for analysis or is being analyzed at 520.

The agent 126 waits for the results of the completed analysis at 520 to decide whether to permit or deny the execution of the file clean.exe. If permitted to execute (due to the analysis at 520 having determined that the file clean.exe is not infected with malicious code), the file may be executed from the source volume 508 or from the shadow copy device dev\snap1 510. If the analysis determines that the file contains malicious code, then execution of the file is denied or is stopped (if already executing).

Accordingly from the foregoing, it can be seen that reanalysis of the file at the shadow copy device 510 need not be performed. Rather than performing such separate reanalysis, the redirection technique leverages the ongoing (shown at 526) analysis that is performed by the agent 126 as files are created, modified, copied, etc.

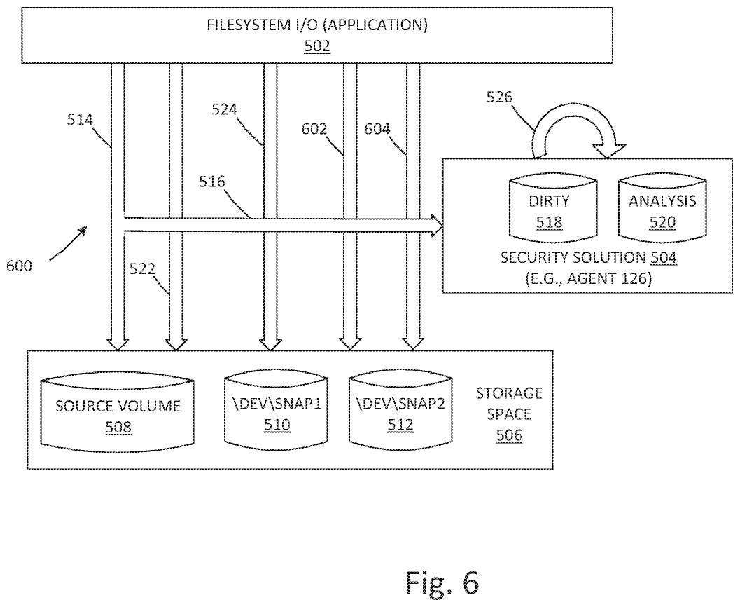

FIG. 6 is another example workflow 600 of the redirection technique. The workflow 600 shows the previous components and operations of the workflow 500 previously described above, plus additional operations.

Specifically, a subsequent operation is performed at 602 to create another snapshot of the source volume C:\ 508, and the snapshot (shadow copy volume) is depicted in FIG. 6 as the shadow copy device dev\snap2 512. The malicious file bad.exe is present in the source volume C:\508, and is therefore also present in the snapshot (shadow copy volume). The agent 126 attaches to this newly created shadow copy volume, and the shadow copy cache map is accordingly also updated to add an entry that maps the GUID of the shadow copy volume to the source volume C:\ 508.

At this point, the analysis 520 described above and/or other analysis of the file bad.exe has already been completed, such that the analysis 520 has identified the file bad.exe in the source volume C:\ 508 as being a malicious file. Then at 604, a request to execute the malicious file contained in the shadow copy volume (e.g., \dev\snap2\foo\bad.exe) is detected by the agent 126.

The agent 126 replaces the path specified in the request, from the shadow copy device dev\snap2 512 to the source volume 508 at C:\foo\bad.exe. The agent 126 checks the dirty queue 518 for the malicious file, and determines that the malicious file bad.exe is not awaiting analysis in the dirty queue 510. The agent 126 therefore checks a database or other historical record of previous analysis results, and determines that the malicious file bad.exe has already been identified as an unapproved file. The agent 126 accordingly blocks execution of the malicious file bad.exe from the shadow copy device dev\snap2 512.

Hence as described above, a reanalysis of the (same) malicious file in the shadow copy device dev\snap2 512 need not be performed.

From the foregoing description of the various embodiments, the secure execution of files from shadow copy devices can be handled. Furthermore and because a majority of snapshots are in read-only format, utilizing the contents of the source volume for analysis and execution, such as via the above-described redirection technique(s), provides advantages over performing a large amount of reanalysis of contents of a shadow copy device. For example, improvements in performance are possible, while still being able to manage/control the secure execution of files on a shadow copy device.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-6. For example, computing devices capable of acting as host devices may be deployed in virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to control the execution of files from copy devices for security purposes.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method to handle execution of files contained in a copy device in a virtualized computing environment, the method comprising:
creating the copy device, including copying a particular file from a source volume to the copy device;
tracking activity of the copy device, including a request to execute the particular file from the copy device;
in response to the tracking having detected the request to execute the particular file, obtaining an analysis of the particular file to determine whether the particular file is a malicious file that contains malicious code; and
in response to determination that the particular file is a malicious file that contains malicious code, denying execution of the particular file.

2. The method of claim 1, further comprising:
in response to determination that malicious code is absent from the particular file, permitting execution of the particular file, wherein the particular file is executed from the copy device.

3. The method of claim 1, wherein:
the particular file is initially a trusted file as determined by a security agent after an initial analysis, and
malicious code is written into the particular file that has been determined to be a trusted file prior to creating the copy device and before the particular file, having malicious code written therein, is analyzed again by the security agent, such that the particular file copied into the copy device includes malicious code.

4. The method of claim 1, wherein obtaining the analysis of the particular file includes performing, by a security agent, the analysis on the particular file contained in the copy device.

5. The method of claim 1, wherein obtaining the analysis of the particular file includes performing a redirection technique to perform, by a security agent, the analysis of the particular file at the source volume rather than analysis, by the security agent, of the particular file at the copy device.

6. The method of claim 5, wherein performing the redirection technique includes:
in response to the creating the copy device, placing the particular file in a queue for analysis by the security agent to determine whether the particular file is the malicious file;
creating an entry in a cache map that relates an identifier of the copy device to the source volume;
in response to the tracking having detected the request to the execute the particular file, using the identifier as a key to identify the source volume and redirecting the request to the identified source volume; and
waiting for completion, by a security agent, of the analysis of the particular file in the queue before deciding whether to grant the request, wherein the denying the execution of the particular file is in response to the completed analysis by the security agent having determined that the particular file is a malicious file, and wherein permitting the execution of the particular file is in response to the completed analysis by the security agent having determined that the particular file is a trusted file.

7. The method of claim 6, wherein the execution of the particular file, which is determined to be a trusted file, is performed from the source volume.

8. The method of claim 6, wherein the copy device is a first copy device, the entry in the cache map is a first entry, the identifier is a first identifier, and the request is a first request, and wherein the method further comprises:
creating a second copy device, including copying the particular file, which is a malicious file, from the source volume to the second copy device;
creating a second entry in the cache map that relates a second identifier of the second copy device to the source volume;
tracking activity of the second copy device, including a second request to execute the particular file from the second copy device;
in response to detection of the second request, using the second identifier as another key to identify the source volume and redirecting the second request to the identified source volume;
in response to determining that the particular file is absent from the queue, checking historical information to determine whether the particular file is a malicious file; and
denying the execution of the particular file is in response to the historical information indicating that the particular file is a malicious file.

9. A non-transitory computer-readable medium having instructions stored thereon, which in response to execution by one or more processors, cause the one or more processors to perform or control performance of operations to handle execution of files contained in a copy device in a virtualized computing environment, the operations comprising:
creating the copy device, including copying a particular file from a source volume to the copy device;
tracking activity of the copy device, including a request to execute the particular file from the copy device;
in response to the tracking having detected the request to execute the particular file, performing a redirection technique to redirect the request to the source volume, wherein performing the redirection request includes:
in response to the creating the copy device, placing the particular file in a queue for analysis to determine whether the particular file is a malicious file;
creating an entry in a cache map that relates an identifier of the copy device to the source volume;
in response to the tracking having detected the request to the execute the particular file, using the identifier as a key to identify the source volume and redirecting the request to the identified source volume;
waiting for completion of the analysis of the particular file in the queue before deciding whether to grant the request;
denying the execution of the particular file is in response to the completed analysis having determined that the particular file is a malicious file; and
permitting the execution of the particular file in response to the completed analysis having determined that the particular file is a trusted file.

10. The non-transitory computer-readable medium of claim 9, wherein the execution of the particular file, which is determined to be a trusted file, is performed from the source volume.

11. The non-transitory computer-readable medium of claim 9, wherein the copy device is a first copy device, the entry in the cache map is a first entry, the identifier is a first identifier, and the request is a first request, and wherein the method further comprises:
creating a second copy device, including copying the particular file, which is a malicious file, from the source volume to the second copy device;
creating a second entry in the cache map that relates a second identifier of the second copy device to the source volume;
tracking activity of the second copy device, including a second request to execute the particular file from the second copy device;
in response to detection of the second request, using the second identifier as another key to identify the source volume and redirecting the second request to the identified source volume;
in response to determining that the particular file is absent from the queue, checking historical information to determine whether the particular file is a malicious file; and
denying the execution of the particular file in response to the historical information indicating that the particular file is a malicious file.

12. The non-transitory computer-readable medium of claim 9, wherein the execution of the particular file, which is determined to be a trusted file, is performed from the copy device.

13. The non-transitory computer-readable medium of claim 9, wherein:
the particular file is initially a trusted file as determined by a security agent after an initial analysis, and
malicious code is written into the particular file that has been determined to be a trusted file prior to creating the copy device and before the particular file, having malicious code written therein, is analyzed again by the security agent, such that the particular file copied into the copy device includes malicious code.

14. The non-transitory computer-readable medium of claim 9, wherein the copy device is a shadow copy device that is configured as a logical arrangement of storage locations.

15. A computing device in a virtualized computing environment, the computing device comprising:
a processor; and
a non-transitory computer-readable medium coupled to the processor and having instructions stored thereon, which in response to execution by the processor, cause the processor to perform or control performance of operations to handle execution of files contained in a copy device, wherein the operations include:
tracking activity of the copy device, including a request to execute a particular file from the copy device;
in response to the request to execute the particular file, determining whether the particular file is a malicious file that contains malicious code; and
based on determination of whether the particular file is a malicious file, permitting or denying execution of the particular file from the copy device.

16. The computing device of claim 15, wherein:
the particular file is initially a trusted file as determined by a security agent after an initial analysis, and
malicious code is written into the particular file that has been determined to be a trusted file prior to creation of the copy device and before the particular file, having malicious code written therein, is analyzed again by the security agent, such that the particular file copied into the copy device includes malicious code.

17. The computing device of claim 15, wherein the operations of determining whether the particular file is a malicious file that contains malicious code include operations of:
analyzing, by a security agent, the particular file at the copy device.

18. The computing device of claim 15, wherein the operations of determining whether the particular file is a malicious file that contains malicious code include operations of:
analyzing, by a security agent, the particular file at the source volume, including operations of performing a redirection technique to redirect the request from the copy device to the source volume.

19. The computing device of claim 18, wherein the operations of performing the redirection technique to redirect the request from the copy device to the source volume include operations of:
in response to creating the copy device, placing the particular file in a queue for analysis by the security agent to determine whether the particular file is a malicious file;
creating an entry in a cache map that relates an identifier of the copy device to the source volume;
in response to the tracking having detected the request to the execute the particular file, using the identifier as a key to identify the source volume and redirecting the request to the identified source volume;
waiting for completion by the security agent of the analysis of the particular file in the queue before deciding whether to grant the request;
denying the execution of the particular file is in response to the completed analysis having determined that the particular file is the malicious file; and
permitting the execution of the particular file in response to the completed analysis by the security agent having determined that the particular file is a trusted file.

20. The computing device of claim 19, wherein the copy device is a first copy device, the entry in the cache map is a first entry, the identifier is a first identifier, and the request is a first request, and wherein the operations further include:
creating a second copy device, including copying the particular file, which is a malicious file, from the source volume to the second copy device;
creating a second entry in the cache map that relates a second identifier of the second copy device to the source volume;
tracking activity of the second copy device, including a second request to execute the particular file from the second copy device;
in response to detection of the second request, using the second identifier as another key to identify the source volume and redirecting the second request to the identified source volume;
in response to determining that the particular file is absent from the queue, checking historical information to determine whether the particular file is a malicious file; and
denying the execution of the particular file in response to the historical information indicating that the particular file is a malicious file.
